(19) United States
(12) Patent Application Publication
(10) Pub. No.: US 2024/0251075 A1
(43) Pub. Date: Jul. 25, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 18/628,466

(22) Filed: Apr. 5, 2024

Related U.S. Application Data
(63) Continuation of application No. PCT/CN2022/123256, filed on Sep. 30, 2022.

(30) Foreign Application Priority Data
Oct. 6, 2021 (WO) PCT/CN2021/122517

(51) Int. Cl. H04N 19/105; H04N 19/176; H04N 19/88

(52) U.S. Cl. CPC H04N 19/105; H04N 19/176; H04N 19/88

(57) ABSTRACT

Embodiments of the present disclosure provide a solution for video processing. A method for video processing is proposed. The method comprises: determining, during a conversion between a target video block of a video and a bitstream of the video, a set of motion vector prediction (MVP) candidates of the target video block based on decoded information of the target video block; sorting the set of MVP candidates based on respective template matching costs of the set of MVP candidates; and performing the conversion based on the sorting.

### CROSS-REFERENCE TO RELATED APPLICATIONS

This application is a continuation of International Application No. PCT/CN2022/123256, filed on Sep. 30, 2022, which claims the benefit of International Application No. PCT/CN2021/122517 filed on Oct. 6, 2021. The entire contents of these applications are hereby incorporated by reference in their entireties.

### FIELD

Embodiments of the present disclosure relates generally to video coding techniques, and more particularly, to template matching costs-based motion vector prediction (MVP) improvement.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a target video block of a video and a bitstream of the video, a set of motion vector prediction (MVP) candidates of the target video block based on decoded information of the target video block; sorting the set of MVP candidates based on respective template matching costs of the set of MVP candidates; and performing the conversion based on the sorting.

The method in accordance with the first aspect of the present disclosure determines a set of MVP candidates to be sorted and sorts the set of MVP candidates based on the template matching costs. Compared with the conventional solution where the MVP candidates are constructed without being sorted based on the template matching costs, the sorted MVP candidates can be more appropriate, and thus the coding effectiveness and coding efficiency can be improved.

In a second aspect, another method for video processing is proposed. The method comprises: determining, during a conversion between a target video block of a video and a bitstream of the video, respective template matching costs of a plurality of motion vector prediction (MVP) candidates of the target video block, the plurality of MVP candidates being in an advanced motion vector predication (AMVP) mode; determining an MVP candidate list based on the respective template matching costs; and performing the conversion based on the MVP candidate list.

The method in accordance with the second aspect of the present disclosure determines an MVP candidate in AMVP mode based on the template matching costs. Compared with the conventional solution where the MVP candidate list is determined without using the template matching costs, the template matching cost-based MVP candidate can be improved, and thus the coding effectiveness and coding efficiency can be improved.

In a third aspect, an apparatus for processing video data is proposed. The apparatus for processing video data comprises a processor and a non-transitory memory with instructions thereon, wherein the instructions upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a video which is generated by a method performed by a video processing apparatus, wherein the method comprises: determining, based on decoded information of a target video block of the video, a set of motion vector prediction (MVP) candidates of the target video block; sorting the set of MVP candidates based on respective template matching costs of the set of MVP candidates; and generating the bitstream based on the sorting.

In a sixth aspect, a method for storing a bitstream of a video is proposed. The method comprises: determining, based on decoded information of a target video block of the video, a set of motion vector prediction (MVP) candidates of the target video block; sorting the set of MVP candidates based on respective template matching costs of the set of MVP candidates; generating the bitstream based on the sorting; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by a video processing apparatus, wherein the method comprises: determining respective template matching costs of a plurality of motion vector prediction (MVP) candidates of a target video block of the video, the plurality of MVP candidates being in an advanced motion vector predication (AMVP) mode; determining an MVP candidate list based on the respective template matching costs; and generating the bitstream based on the MVP candidate list.

In an eighth aspect, another method for video processing is proposed. The method for storing a bitstream of a video, comprising: determining respective template matching costs of a plurality of motion vector prediction (MVP) candidates of a target video block of the video, the plurality of MVP candidates being in an advanced motion vector predication (AMVP) mode; determining an MVP candidate list based on the respective template matching costs; generating the bitstream based on the MVP candidate list; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing positions of spatial and temporal neighboring blocks used in AMVP/merge candidate list construction;

FIG. 5 illustrates an example diagram showing positions of non-adjacent candidate in ECM;

FIG. 6 illustrates an example diagram showing an example of the positions for non-adjacent TMVP candidates;

FIG. 7 illustrates an example diagram showing an example of the template;

FIG. 8 illustrates an example diagram showing a reference template specified by a MV;

FIG. 9 illustrates an example diagram showing a reference template specified by the MV associated with an MVP candidate;

FIG. 10 illustrates an example diagram showing an example of the template matching cost ordering based MVP list construction;

FIG. 11 illustrates an example diagram showing an example of the template matching derivation and sorting process;

FIG. 12 illustrates an example diagram showing an example of MVP list construction for merge mode;

FIG. 13 illustrates an example diagram showing another example of MVP list construction for merge mode;

FIG. 14 illustrates an example diagram showing an example of MVP list construction for AMVP mode;

FIG. 15 illustrates an example diagram showing another example of MVP list construction for AMVP mode;

FIG. 16 illustrates an example diagram showing examples of non-adjacent positions;

FIG. 17 illustrates a flowchart of a method for video processing in accordance with some embodiments of the present disclosure;

FIG. 18 illustrates another flowchart of a method for video processing in accordance with some embodiments of the present disclosure; and

FIG. 19 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

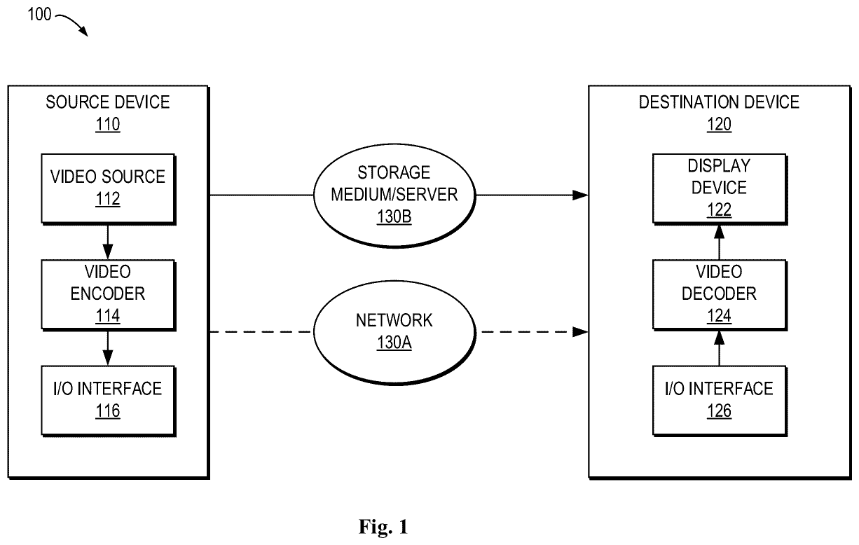

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

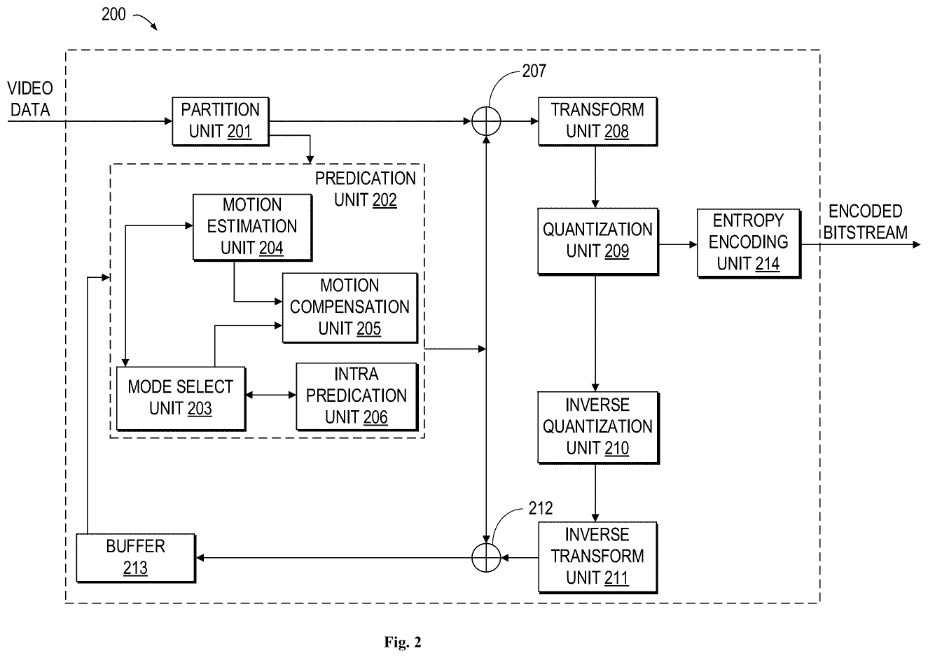

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

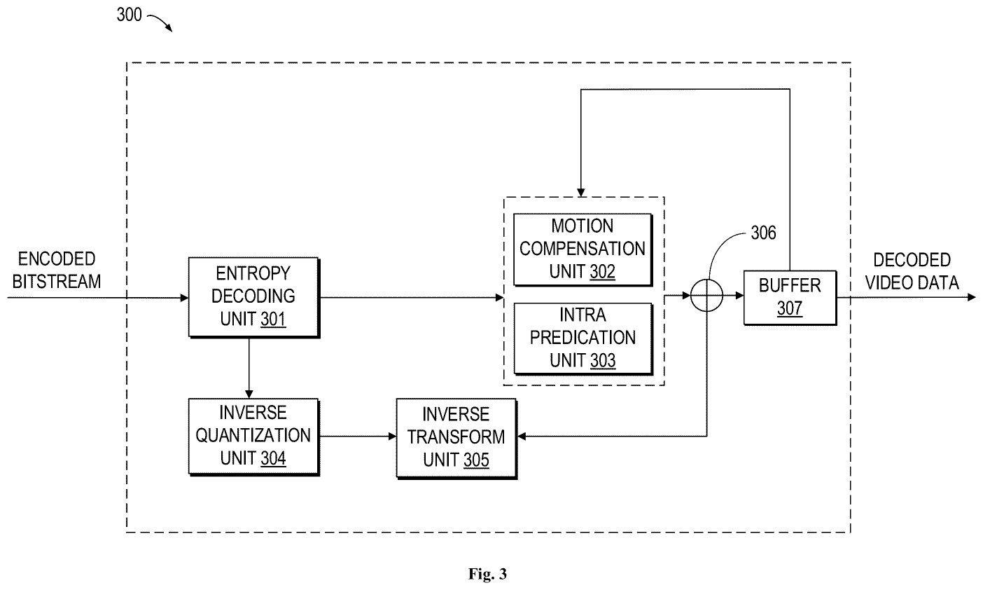

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video coding technologies. Specifically, it is about motion vector prediction (MVP) construction method in video coding. The ideas may be applied individually or in various combination, to any video coding standard or non-standard video codec.

### 2. Background

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

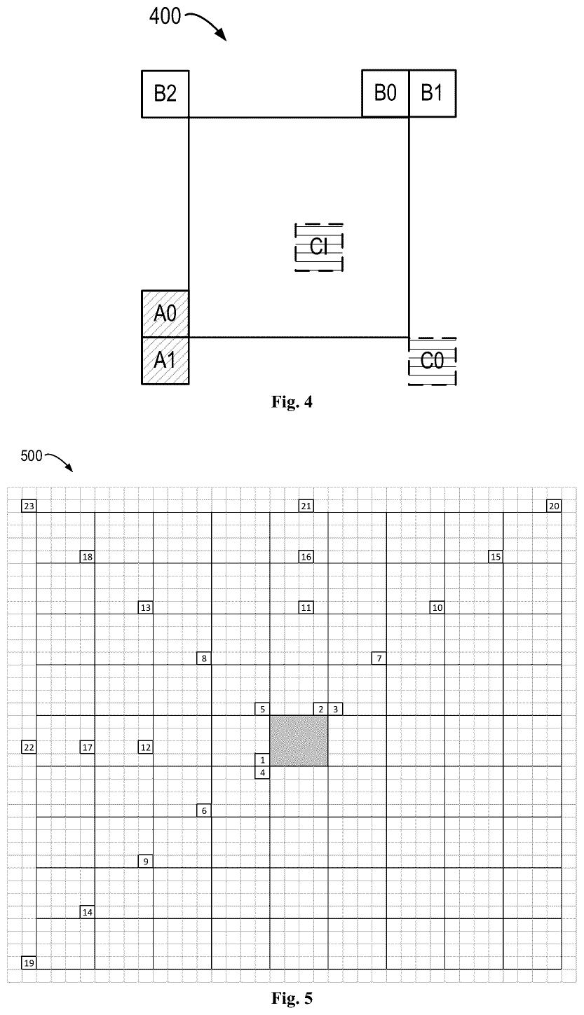

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates an example diagram 400 showing positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different co-located positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. FIG. 5 illustrates an example diagram 500 showing positions of non-adjacent candidate in ECM. In ECM software, Non-adjacent MVP are inserted between TMVP and HMVP, where the distances between non-adjacent spatial candidates and current coding block are based on the width and height of current coding block as depicted in FIG. 5.

### 3. Problems

(1) Existing MVP list construction methods target at building a subset with constant MVP number from a given candidate set, which is normally realized by selecting the available candidates in a predefined order. This strategy, however, does not exploit the prior information produced during encoding/decoding process, which may lead to the mismatch between the true motion information and that of the candidates in the constructed MVP list.

(2) The current non-adjacent MVP only considers the spatial positions that locate in the same frame as the current block, whereas the non-adjacent temporal positions may also provide valuable motion information that are absent within the spatial MVP candidates.

(3) Existing pruning process for MVP candidate only regards identical MVs as redundancy. Consequently, the constructed MVP list may contain quite similar MVs such that the diversity within the list is limited.

### 4. Detailed Descriptions

In this disclosure, an optimized MVP list derivation method based on template matching cost ordering is proposed. Instead of constructing the MVP list based on a predefined traversing order, an optimized MVP selecting approach is investigated by taking advantage of the matching cost in the reconstructed template region, such that more appropriate candidates are included in the list.

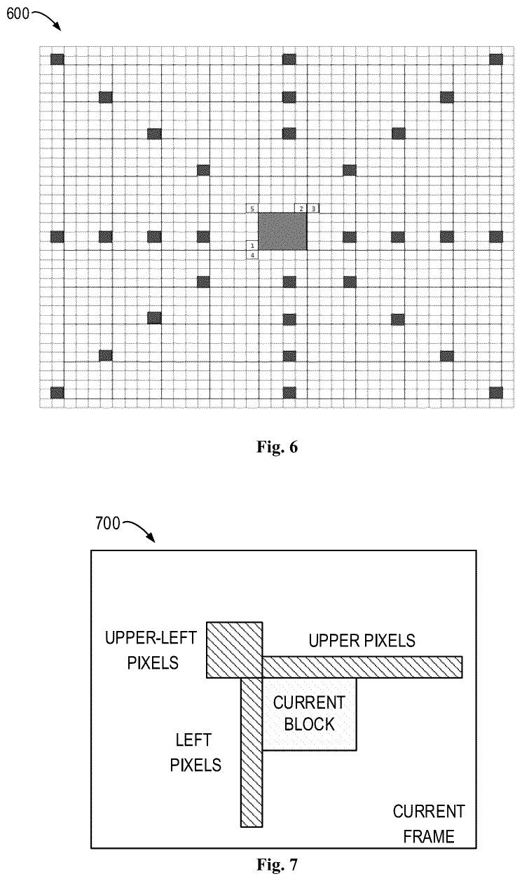

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on. FIG. 6 illustrates an example diagram 600 showing an example of the positions for non-adjacent TMVP candidates.

The detailed embodiments below should be considered as examples to explain general concepts. These embodiments should not be interpreted in a narrow way. Furthermore, these embodiments can be combined in any manner. Combination between this disclosure and other disclosures are also applicable.

### Non-Adjacent TMVP

1. It is proposed to make use of the TMVP in a non-adjacent area to further improve the effectiveness of the MVP list.
a) In one example, a non-adjacent area may be any block (such as 4×4 block) in a reference picture and neither inside nor adjacent to the collocated block in the reference picture of the current block.
b) FIG. 7 illustrates an example diagram showing an example of the template 700. In one example, the positions of the non-adjacent TMVP candidates are illustrated in FIG. 7, where black blocks represent the potential non-adjacent TMVP positions. It should be noted that this figure only provides an example for non-adjacent TMVP, and the positions are not limited to the indicated blocks. In other cases, non-adjacent TMVP may locate in any other positions in one or more reconstructed frames.

2. The maximum allowed non-adjacent TMVP number in the MVP list may be signaled in the bitstream.
a) In one example, the maximum allowed number can be signaled in SPS or PPS.

3. The non-adjacent TMVP candidates may locate in the nearest reconstructed frame, but it may also locate in other reconstructed frames.
a) Alternatively, non-adjacent TMVP candidates may locate in the collocated picture.
b) Alternatively, it is signaled in which picture non-adjacent TMVP candidates may locate.

4. Non-adjacent TMVP candidates may locate in multiple reference pictures.

5. The distances between a non-adjacent area associated with a TMVP candidate and current coding block may be related to the property of the current block.
a) In one example, the distances depend on the width and height of current coding block.
b) In other cases, the distances may be signaled in the bitstream as a constant.

### Definition of the Template

6. Template represents the reconstructed region that can be used to estimate the priority of a MVP candidate, which may locate in different positions with variable shape.
a) In one example, a template may comprise of the reconstructed regions in three positions, which are upper pixels, left pixels and upper-left pixels, as presented in FIG. 7.
b) It should be noted that the template may not necessarily be in rectangular shape, it can be in arbitrary shape, e.g., triangle or polygon.
c) In one example, the template regions may be utilized either in separate or combined manner.
d) A template may only comprise samples from one component such as luma, or from multiple components such as luma and chroma.

7. The template may not necessarily locate in the current frame, it may locate in any other reconstructed frame.

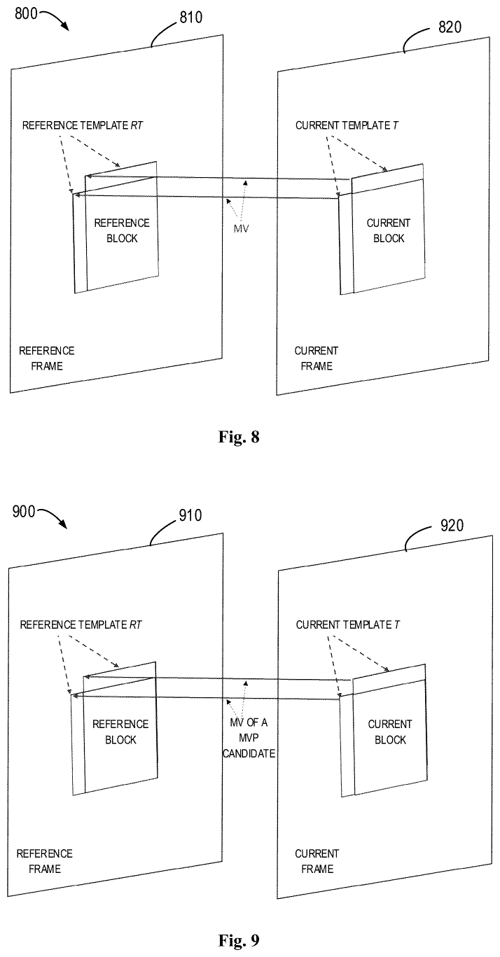

8. In one example, a reference template region with the same shape as the template of the current block may be located with a MV, as shown in FIG. 8, which illustrates an example diagram 800 showing a reference template of a reference frame 810 specified by a MV of a current template of a current frame 820.

9. In one example, the template may not necessarily locate in adjacent area, it may locate in non-adjacent areas that are far away from the current block.

10. In one example, a template may not necessarily contain all the pixels in a certain region, it may contain part of the pixels in a region.

### Template Matching Based MVP Candidate Ordering

11. In this disclosure, template matching cost associated with a certain MVP candidate serves as a measurement to evaluate the consistency of this candidate and true motion information. Based on this measurement, a more efficient order is generated by sorting the priority of each MVP candidate.
a) FIG. 9 illustrates and example diagram 900 showing a reference template of a reference frame 910 specified by the MV associated with an MVP candidate of a current template of a current frame 920. In one example, the template matching cost C is evaluated with mean of square error (MSE), as calculated below:

$$C = \frac{{\sum }_{( i j ) ∈ T} {( T ( i , j ) - R T ( i , j ) )}^{2}}{N} ,$$

where T represents the template region, RT represents the corresponding reference template region specified by the MV within MVP candidate (as shown in FIG. 9), N is the pixel number within the template.
b) In one example, the template matching cost can be evaluated with sum of square error (SSE), sum of absolute difference (SAD), sum of absolute transformed difference (SATD) or any other criterion that can measure the difference between two regions.

12. All the MVP candidates are sorted in an ascending order regarding the corresponding template matching cost, and the MVP list is constructed by traversing the candidates in the sorted order until the MVP amount reaches the maximum allowed number. In this way, a candidate with a lower matching cost has a higher priority to be included in the ultimate MVP list.
a) In one example, the sorting process may be conducted towards all the MVP candidates.
b) Alternatively, this process may also be applied to part of candidates, e.g., non-adjacent MVP candidates, HMVP candidates or any other group of candidates.
c) Alternatively, furthermore, which categories of MVP candidates (e.g., non-adjacent MVP candidates are belonging to one category, HMVP candidates are belonging to another category) and/or what kinds of group of candidates should be reordered may be dependent on the decoded information, e.g., block dimension/coding methods (e.g., CIIP/MMVD) and/or how many available MVP candidates before being reordered for a given kind/group.
   1. In one example, the sorting process may be conducted for a joint group which contains only one category of MVP candidates.
   2. In one example, the sorting process may be conducted for a joint group which contains more than one category of MVP candidates.
      a) In one example, for a first coding method (e.g., regular/CIIP/MMVD/GPM/TPM/subblock merge mode), the sorting process can be conducted for a joint group of non-adjacent MVP, non-adjacent TMVP and HMVP candidates. For a second coding method (e.g., the template matching merge mode), the sorting process can be conducted for a joint group of adjacent MVP, non-adjacent TMVP, non-adjacent MVP and HMVP candidates.
   3. In one example, the sorting process may be conducted for a joint group which contains partial of available MVP candidates within the categories.
      a) In one example, for regular/CIIP/MMVD/TM/GPM/TPM/subblock merge mode, or for regular/affine AMVP mode, the sorting process can be conducted for a joint group of all or partial candidates from one or multiple categories.
   4. In above examples, the category may be
      i. adjacent neighboring MVPs;
      ii. adjacent neighboring MVPs at specific location(s);
      iii. TMVP MVPs;
      iv. HMVP MVPs;
      v. Non-adjacent MVPs;
      vi. Constructed MVPs (such as pairwise MVPs);
      vii. Inherited affine MV candidates;
      viii. Constructed affine MV candidates;
      ix. SbTMVP candidates.
d) In one example, this process may be conducted multiple times on different set of candidates.
   1. For example, a set of candidates (such as non-adjacent MVP candidates) may be sorted, and the N non-adjacent MVP candidates with the lowest costs may be put into the candidate list. After the whole candidate list is constructed, the costs of candidates in the list may be calculated and the candidates may be reordered based on the costs.

13. The proposed sorting method can also be applied to AMVP mode.
a) In one example, the MVP in AMVP mode can be extended with non-adjacent MVP, non-adjacent TMVP and HMVP.
b) In one example, MVP list for AMVP mode comprises K candidates, which are selected from M categories, such as adjacent MVPs, non-adjacent MVPs, non-adjacent TMVPs and HMVPs wherein K and M are integers.
   1. In one example, K could be smaller than M, or equal to M or greater than M.
   2. In one example, one candidate is selected from each category.
   3. Alternatively, for a given category, no candidate is selected.
   4. Alternatively, for a given category, more than 1 candidate is selected.
   5. In one example, MVP list for AMVP mode comprises 4 candidates, which are selected from adjacent MVPs, non-adjacent MVPs, non-adjacent TMVPs and HMVPs.
   6. In one example, each category of MVP candidates is respectively sorted with template matching cost, and the one with minimum cost in the corresponding type is selected and included in the MVP list.
   7. Alternatively, adjacent MVP candidates and a joint group of non-adjacent MVP, non-adjacent TMVP together with HMVP candidates are respectively sorted with template matching cost. One adjacent candidate with the minimum template matching cost is selected from adjacent MVP candidates, and three other candidates are derived by traversing the candidates in the joint group in an ascending order of template matching cost.
   8. In one example, MVP list for AMVP mode comprises 2 candidates, one comes from adjacent MVP and the other comes from non-adjacent MVP, non-adjacent TMVP or HMVP. In particular, adjacent MVP candidates and a joint group of non-adjacent MVP, non-adjacent TMVP together with HMVP are respectively sorted with template matching cost, and the one with minimum cost in the corresponding type (or group) is included in the MVP list.

14. The proposed sorting methods may be applied to other coding methods, e.g., for constructing a block vector list of IBC coded blocks.

15. The usage of this method may be controlled with different coding level syntax, including but not limit to one or multiple of PU, CU, CTU, slice, picture, sequence levels.

### Pruning for MVP Candidates

16. The pruning for MVP candidates aims to increase the diversity within the MVP list, which can be realized by using appropriate threshold TH.
a) In one example, if the two candidates point to same reference frame, they may both be included to MVP list only if the absolute difference between the corresponding X and Y components are either or both larger (or no smaller) than TH.

17. The pruning threshold can be signaled in the bitstream.
b) In one example, the pruning threshold can be signaled either in PU, CU, CTU or slice level.

18. The pruning threshold may depend on the characteristics of the current block.
c) In one example, the threshold may be derived by analyzing the diversity among the candidates.
d) In one example, the optimal threshold can be derived through RDO.

### 5. Embodiments

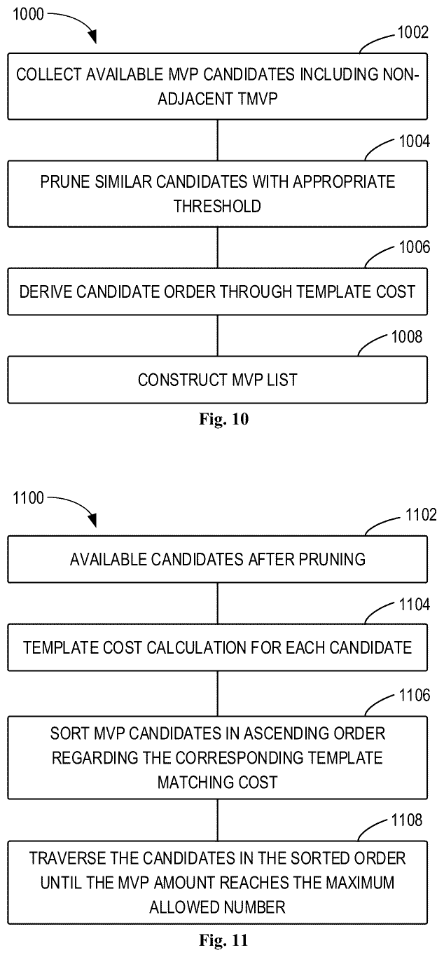

FIG. 10 illustrates an example diagram 1000 showing an example of the template matching cost ordering based MVP list construction. An example of the coding flow for the template matching cost ordering based MVP list construction is presented in FIG. 10. At block 1002, available MVP candidates including non-adjacent TMVP are collected. At block 1004, similar candidates are pruned with appropriate threshold. At block 1006, candidate order is derived through template cost. At block 1008, MVP list is constructed.

FIG. 11 illustrates an example diagram 1100 showing an example of the template matching derivation and sorting process. At block 1102, available candidates after pruning are obtained. At block 1104, template cost is calculated for each candidate. At block 1106, MVP candidates are sorted in ascending order regarding the corresponding template matching cost. At block 1108, the candidates in the sorted order are traversed until the MVP amount reaches the maximum allowed number.

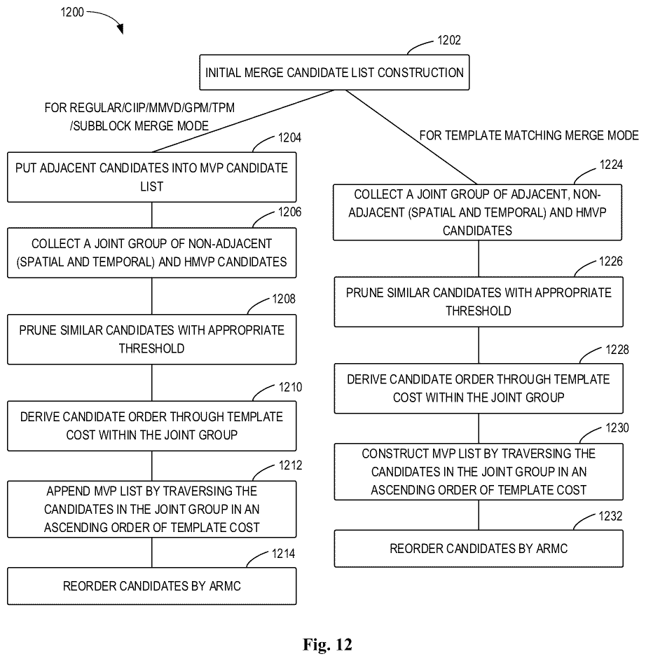

FIG. 12 illustrates an example diagram 1200 showing an example of MVP list construction for merge mode. FIG. 12 provides an example of the proposed MVP list construction for merge mode. When encoder/decoder starts to build a MVP candidate list for merge mode at block 1202, different methods are used for different merge modes. In particular, if the current mode is regular/CIIP/MMVD/GPM/TPM/subblock merge mode, adjacent candidates are firstly put into MVP candidate list at block 1204. Then a joint group which contains one or more than one category of MVP candidates (e.g. non-adjacent and HMVP candidates as in FIG. 12, note that a joint group can also comprises different partial or combination of candidates) is built at block 1206, and pruning operation with appropriate threshold is conducted within the joint group at block 1208. Subsequently, template matching cost associated with each candidates within the join group is calculated as described in bullet 11 at block 1210. After that, encoder/decoder will append MVP list by traversing the candidates in the joint group in an ascending order of template matching cost until all the candidates in the joint group are traversed or MVP list reaches maximum allowed number at block 1212. If all the candidates within the joint group are traversed and MVP list still has vacant positions, remaining candidates which are not belong to the joint group will be included in the MVP list in a predefined order until the list reaches maximum allowed candidate number. After MVP list is constructed, it can be further reordered with ARMC at block 1214.

If current merge mode is template matching merge mode, a joint group which contains different category of MVP candidates (e.g. adjacent, non-adjacent and HMVP candidates as in FIG. 12, note that a joint group can also comprises different partial or combination of candidates) is firstly built at block 1224, then pruning process and template matching cost derivation are conducted at block 1226 and block 1228 in the same way as regular/CIIP/MMVD/GPM/TPM/subblock merge mode. Then, encoder/decoder will construct MVP list by traversing the candidates in the joint group in an ascending order of template matching cost until all the candidates in the joint group are traversed or MVP list reaches maximum allowed number at block 1230. If all the candidates within the joint group are traversed and MVP list still has vacant positions, remaining candidates which are not belong to the joint group will be included in the MVP list in a predefined order until the list reaches maximum allowed candidate number. After MVP list is constructed, it can be further reordered with ARMC at block 1232.

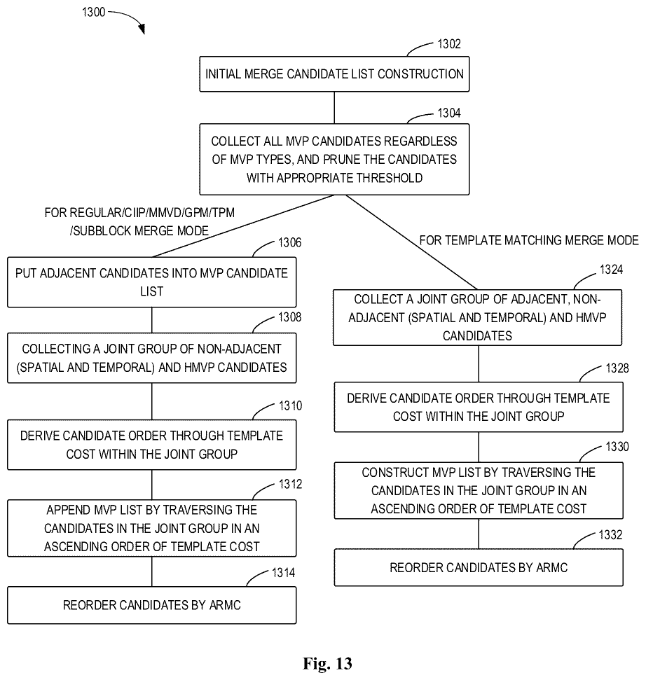

FIG. 13 illustrates an example diagram 1300 showing another example of MVP list construction for merge mode. The difference between the method in FIG. 12 and FIG. 13 is that, in FIG. 13, when encoder/decoder starts to build an MVP candidate list at block 1302, it will firstly collect all the candidates regardless of MVP types, and the pruning operation is conducted for all the candidates at block 1304. Whereas for the example in FIG. 12, the pruning is conducted for partial of candidates (or a joint group).

Similar to FIG. 12, for regular/CIIP/MMVD/GPM/TPM/subblock merge mode, at block 1306, adjacent candidates are put into MVP candidate list. At block 1308, a joint group of non-adjacent (spatial and temporal) and HMVP candidates are collected. At block 1310, a candidate order is derived through template cost within the joint group. At block 1312, MVP list is appended by traversing the candidates in the joint group in an ascending order of template cost. At block 1314, the candidates are reordered by ARMC.

For template matching merge mode, at block 1324, a joint group of adjacent, non-adjacent (spatial and temporal) and HMVP candidates are collected. At block 1328, a candidate order is derived through template cost within the joint group. At block 1330, an MVP list is constructed by traversing the candidates in the joint group in an ascending order of template cost. At block 1332, the candidates are reordered by ARMC.

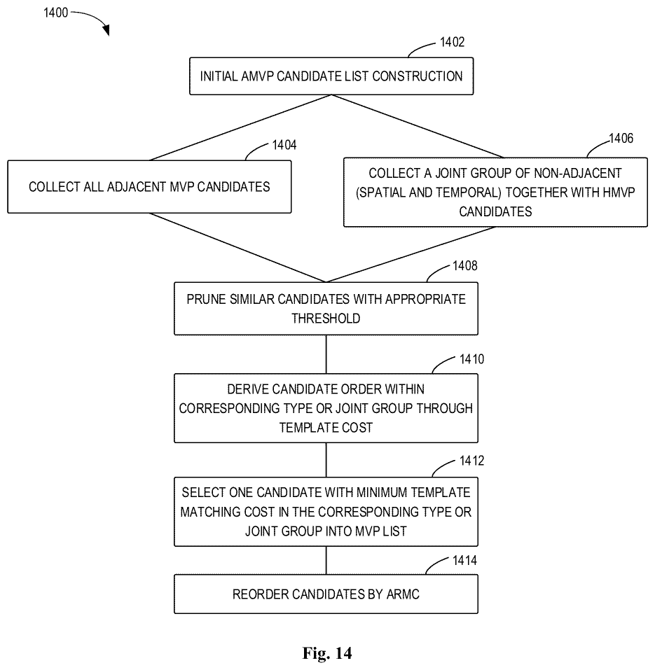

FIG. 14 illustrates an example diagram 1400 showing an example of MVP list construction for AMVP mode. When encoder/decoder starts to build a MVP candidate list for AMVP mode at block 1402, two joint groups are respectively built. One joint group comprises all the adjacent candidates at block 1404 and the other joint group contains partial or all of the remaining candidates (e.g., non-adjacent spatial and temporal MVP together with HMVP at block 1406 as shown in FIG. 14, note that a joint group can also comprises different partial or combination of candidates), and pruning operation with appropriate threshold is conducted within the joint group at block 1408. Subsequently, template matching cost associated with each candidates within the join group is calculated as described in bullet 11 at block 1410. After that, encoder/decoder will select one candidate with minimum template matching cost in the corresponding type or joint group into MVP list at block 1412. After MVP list is constructed, it can be further reordered with ARMC at block 1414.

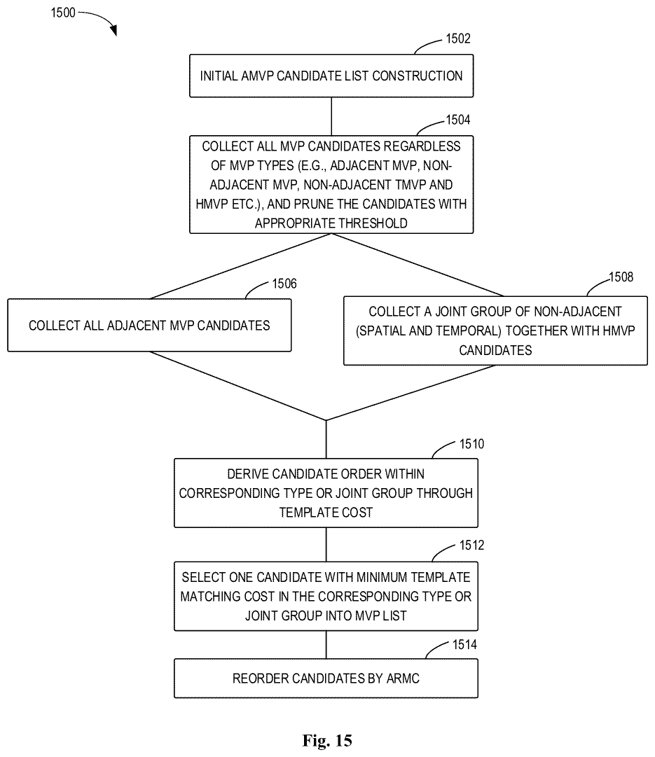

FIG. 15 illustrates an example diagram 1500 showing another example of MVP list construction for AMVP mode. The difference between the method in FIG. 14 and FIG. 15 is that, in FIG. 15, when encoder/decoder starts to build a MVP candidate list at block 1502, it will firstly collect all the candidates regardless of MVP types at block 1504, and the pruning operation is conducted for all the candidates at block 1504. Whereas for the example in FIG. 14, the pruning is conducted for partial of candidates (or a joint group).

Similar to FIG. 14, at block 1506, all adjacent MVP candidates are collected at block 1506. A joint group of non-adjacent (spatial and temporal) together with HMVP candidates are collected. At block 1510, a candidate order is derived within corresponding type or joint group through template cost. At block 1512, one candidate with minimum template cost in the corresponding type or joint group may be selected into MVP list. At block 1514, the candidates are reordered by ARMC.

In this contribution, a method of template matching based MVP candidate list construction (TM-MCLC) is proposed. Instead of putting adjacent, non-adjacent and HMVP candidates into the MVP candidate list in a predefined traversing order, TM-MCLC puts adjacent, non-adjacent (both spatial and temporal) and HMVP candidates into the MVP candidate list in an ascending order of template matching costs.

In ECM, adjacent, non-adjacent and HMVP candidates are put into the MVP candidate list based on a predefined traversing order. With TM-MCLC, non-adjacent and HMVP candidates are put into the MVP candidate list in an ascending order of template matching costs.

More specifically, for template matching merge mode, all available adjacent, non-adjacent MVP and HMVP are collected in a group after pruning operation. Then TM cost associated with each candidate in the group is derived in a similar way to ARMC. Subsequently, all the candidates in the group are sorted in an ascending order regarding the corresponding TM costs. Finally, adjacent, non-adjacent and HMVP candidates are put into the merge candidate list an ascending order of template matching costs. For other merge mode (e.g. regular/CIIP/MMVD/GPM/TPM/subblock merge mode. etc.), TM-MCLC conducts similar operations as in template matching merge mode except the candidate group comprises only non-adjacent and HMVP candidates.

For AMVP mode, MVP list comprises 2 candidates, one comes from adjacent MVP and the other comes from non-adjacent MVP or HMVP. In particular, adjacent MVP candidates and a joint group of non-adjacent MVP together with HMVP are respectively sorted (after pruning operation) with template matching cost, and the one with minimum cost in the corresponding type (or group) is included in the MVP list.

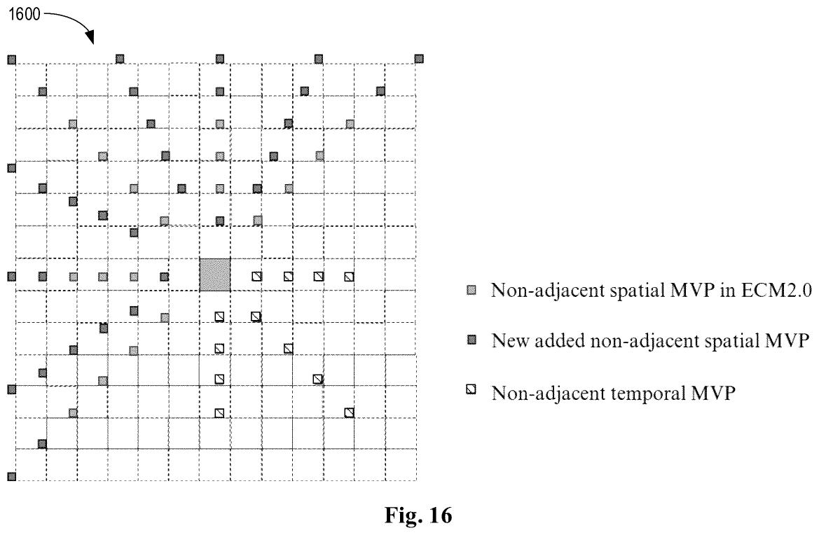

FIG. 16 illustrates an example diagram 1600 showing examples of non-adjacent positions. In this proposal, non-adjacent MVPs in ECM software is further extended with more spatial and non-adjacent temporal positions, as shown in FIG. 16. Besides the 18 positions for non-adjacent spatial MVPs in ECM-2.0, additional 32 spatial positions and 12 non-adjacent temporal positions are introduced, where non-adjacent temporal MVP positions locate in the same reference frame as the adjacent TMVP.

The embodiments of the present disclosure are related to motion vector prediction (MVP) construction and enhancement. As used herein, the term “block” may represent a coding tree block (CTB), a coding tree unit (CTU), a coding block (CB), a coding unit (CU), a prediction unit (PU), a transform unit (TU), a prediction block (PB), a transform block (TB), or a video processing unit comprising a plurality of samples or pixels. A block may be rectangular or non-rectangular.

It is to be understood that the present method for MVP or MVP list construction can be utilized in normal merge and AMVP list construction process and can also be easily extended to other modules that requires MVP derivation, such as merge with motion vector difference (MMVD), Affine motion compensation, Subblock-based temporal motion vector prediction (SbTMVP) and so on.

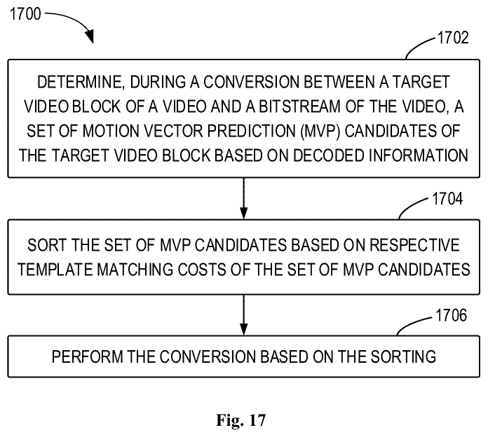

FIG. 17 illustrates a flowchart of a method 1700 for video processing in accordance with some embodiments of the present disclosure. The method 1700 may be implemented during a conversion between a target video block of a video and a bitstream of the video. As shown in FIG. 17, at block 1702, a set of motion vector prediction (MVP) candidates of the target video block is determined based on decoded information of the target video block. At block 1704, the set of MVP candidates is sorted based on respective template matching costs of the set of MVP candidates.

In this way, a set of MVP candidates to be sorted can be determined based on decoded information. The set of MVP candidates can be sorted based on template matching costs. Instead of constructing the MVP list based on a predefined traversing order, sorting the MVP candidates by taking advantage of the template matching cost, more appropriate MVP candidates can be selected for video coding. The coding effectiveness and coding efficiency can be thus improved.

At block 1706, the conversion is performed based on the sorting. In some embodiments, the conversion may include encoding the target video block into the bitstream. Alternatively, or in addition, the conversion may include decoding the target video block from the bitstream.

In some embodiments, the decoded information comprises a block dimension of the target video block. Alternatively, or in addition, in some embodiments, the decoded information comprises a coding tool (or coding method) of the target video block. Examples of coding tool may include but not limited to a combination of intra and inter predication (CIIP) coding tool, a merge mode with motion vector difference (MMVD) coding tool, or any other suitable coding tool or coding method.

In some embodiments, the decoded information comprises a number of available MVP candidates in a group of MVP candidates of the target video block before being reordered. That is, how many available MVP candidates before being reordered for a given kind or given group.

It is to be understood that the example decoded information described above is only for the purpose of illustration, without suggesting any limitation.

In some embodiments, at block 1702, if a first MVP candidate belongs to a first candidate category, the first MVP candidate may be added into the set of MVP candidates. For example, the first candidate category may comprise a non-adjacent MVP candidate category, a history-based motion vector predictor (HMVP) candidate category, or any other suitable category. Alternatively, or in addition, in some embodiments, at block 1702, if a group of MVP candidates belong to a first group type, the group of MVP candidates may be added into the set of MVP candidates. In other words, which categories of MVP candidates and/or what kinds of group of candidates may be reordered or sorted may be dependent on the decoded information.

In some embodiments, the set of MVP candidates comprises a joint group of MVP candidates containing MVP candidates of at least one candidate category. For example, the sorting process may be conducted for a joint group which contains only one category of MVP candidates. For another example, the sorting process may be conducted for a joint group which contains more than one category of MVP candidates.

In some embodiments, at block 1702, if the coding tool of the target video block comprises a first coding tool, a joint group of non-adjacent MVP candidate, non-adjacent temporal motion vector prediction (TMVP) candidate, and history-based motion vector predictor (HMVP) candidate may be determined as the set of MVP candidates. In some embodiments, examples of the first coding tool may include but not limited to a regular merge mode coding tool, a combination of intra and inter predication (CIIP) merge mode coding tool, a merge mode with motion vector difference (MMVD) coding tool, a geometric partitioning mode (GPM) coding tool, a triangle partition mode (TPM) coding tool, a subblock merge mode coding tool, or any other suitable coding tool.

In some embodiments, at block 1702, if the coding tool of the target video block comprises a second coding tool, a joint group of adjacent MVP candidate, non-adjacent temporal motion vector prediction (TMVP) candidate, non-adjacent MVP candidate and history-based motion vector predictor (HMVP) candidate may be determined as the set of MVP candidates. For example, the second coding tool may comprise a template matching merge mode coding tool, or other suitable coding tool.

In some embodiments, the set of MVP candidates comprise a joint group containing a partial of available MVP candidates of at least one candidate category.

In some embodiments, at block 1702, if the coding tool of the target video block comprises a third coding tool, a joint group of all or a partial of candidates of at least one candidate category may be determined as the set of MVP candidates. Examples of the third coding tool may include but not limited to: a regular merge mode coding tool, a combination of intra and inter predication (CIIP) merge mode coding tool, a merge mode with motion vector difference (MMVD) coding tool, a template matching (TM) coding tool, a geometric partitioning mode (GPM) coding tool, a triangle partition mode (TPM) coding tool, a subblock merge mode coding tool, a regular merge mode coding tool, an affine advanced motion vector predication (AMVP) coding tool.

In some embodiments, the at least one candidate category may comprise at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category.

In some embodiments, at block 1704, the set of MVP candidates is sorted in an ascending order based on the respective template matching costs.

In some embodiments, the method is applied in constructing a block vector list of intra block copy (IBC) coded blocks or affine coded blocks.

Alternatively, or in addition, in some embodiments, the usage of the method is controlled with a coding level syntax. For example, the coding level comprises at least one of: a prediction unit (PU) level, a coding unit (CU) level, a coding tree unit (CTU) level, a slice level, a picture level or a sequence level.

In some embodiments, a bitstream of a video may be stored in a non-transitory computer-readable recording medium. The bitstream of the video can be generated by a method performed by a video processing apparatus. According to the method, a set of motion vector prediction (MVP) candidates of a target video block of the video is determined based on decoded information of the target video block. The set of MVP candidates is sorted based on respective template matching costs of the set of MVP candidates. A bitstream of the video is generated based on the sorting.

In some embodiments, a set of motion vector prediction (MVP) candidates of a target video block of the video is determined based on decoded information of the target video block. The set of MVP candidates is sorted based on respective template matching costs of the set of MVP candidates. A bitstream of the video is generated based on the sorting. The bitstream is stored in a non-transitory computer-readable recording medium.

According to embodiments of the present disclosure, it is proposed that the MVP candidates used in the video coding may be sorted and improved. In this way, the coding effectiveness and coding efficiency may be improved.

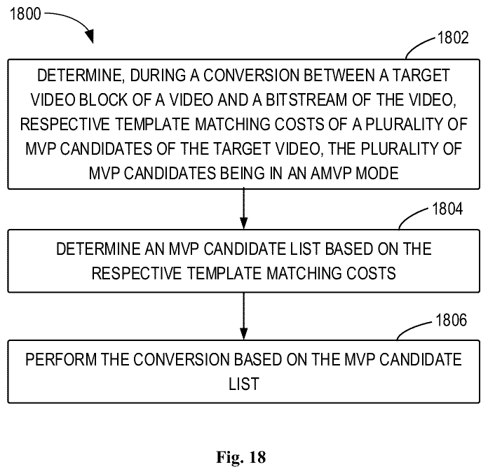

FIG. 18 illustrates a flowchart of a method 1800 for video processing in accordance with some embodiments of the present disclosure. The method 1800 may be implemented during a conversion between a target video block of a video and a bitstream of the video. As shown in FIG. 18, at block 1802, respective template matching costs of a plurality of motion vector prediction (MVP) candidates of the target video block are determined. The plurality of MVP candidates are in an advanced motion vector predication (AMVP) mode. At block 1804, an MVP candidate list is determined based on the respective template matching costs.

In this way, template matching cost-based MVP candidate list construction and sorting can be applied to AMVP mode. In this way, MVP candidate list in AMVP mode can be improved. The coding effectiveness and coding efficiency can be thus improved.

At block 1806, the conversion is performed based on the MVP candidate list. In some embodiments, the conversion may include encoding the target video block into the bitstream. Alternatively, or in addition, the conversion may include decoding the target video block from the bitstream.

In some embodiments, the plurality of MVP candidates comprises at least one of the following: a non-adjacent MVP candidate, a history-based MVP (HMVP) candidate, or a history-based motion vector predictor (HMVP) candidate. That is, the MVP in AMVP mode may be extended with non-adjacent MVP, non-adjacent TMVP or HMVP. It is to be understood that the MVP in AMVP mode may be extended with any suitable MVP candidate category. Scope of the present disclosure is not limited in this regard.

In some embodiments, at block 1804, a first number of MVP candidates from the plurality of MVP candidates are selected as the MVP candidate list. The first number of MVP candidates are of a second number of candidate categories. In other words, MVP list for AMVP mode may comprise a first number (represented by K) of candidates, which are selected from a second number (represented by M) categories. M and K are integers. In some embodiments, the first number K may be less than, equal to or greater than the second number M.

In some embodiments, examples of the candidate categories may include but not limited to an adjacent MVP category, a non-adjacent MVP category, a non-adjacent temporal motion vector prediction (TMVP) MVP category, or a history-based motion vector predictor (HMVP) MVP category.

In some embodiments, one MVP candidate may be selected from MVP candidates of a first candidate category. For example, in some embodiments, one candidate is selected from each category.

In some embodiments, more than one MVP candidate of a third candidate category may be selected. That is, for a given category, more than one candidate is selected.

Alternatively, or in addition, in some embodiments, no MVP candidate of a second candidate category is selected. That is, for a given category, no MVP candidate is selected.

In some embodiments, the first number of MVP candidates are selected from adjacent MVPs, non-adjacent MVPs, non-adjacent temporal motion vector prediction (TMVP) MVPs, or history-based motion vector predictor (HMVP) MVPs. For example, the first number may be 4. That is, the MVP list for AMVP mode comprises 4 candidates, which are selected from adjacent MVPs, non-adjacent MVPs, non-adjacent temporal motion vector prediction (TMVP) MVPs, or history-based motion vector predictor (HMVP) MVPs.

Alternatively, or in addition, in some embodiments, for a candidate category in the second number of candidate categories, the MVP candidates of the candidate category may be sorted based on respective template matching costs of the MVP candidates of the candidate category. An MVP candidate with a minimum cost may be added into the MVP candidate list. For example, each category of MVP candidates is respectively sorted with template matching cost. The one with minimum cost in the corresponding type or corresponding category is selected and included in the MVP list.

In some embodiments, a group of adjacent MVP candidates in the plurality of MVP candidates are sorted based on respective template matching costs of the group of adjacent MVP candidate. An adjacent MVP candidate of the group of adjacent MVP candidates with a minimum cost may be added into the MVP candidate list. Alternatively, or in addition, a joint group of non-adjacent MVP candidates, non-adjacent temporal motion vector prediction (TMVP) MVP candidates, and history-based motion vector predictor (HMVP) MVP candidates in the plurality of MVP candidates are sorted based on respective template matching costs of the joint group of MVP candidates. A third number of MVP candidates in the joint group may be added into the MVP candidate list based on an ascending order of the template matching costs. For example, the third number may be 1 or 3.

In some embodiments, the method is applied in constructing a block vector list of intra block copy (IBC) coded blocks or affine coded blocks.

Alternatively, or in addition, in some embodiments, the usage of the method is controlled with a coding level syntax. For example, the coding level comprises at least one of: a prediction unit (PU) level, a coding unit (CU) level, a coding tree unit (CTU) level, a slice level, a picture level or a sequence level.

In some embodiments, a bitstream of a video may be stored in a non-transitory computer-readable recording medium. The bitstream of the video can be generated by a method performed by a video processing apparatus. According to the method, respective template matching costs of a plurality of motion vector prediction (MVP) candidates of a target video block of the video are determined. The plurality of MVP candidates are in an advanced motion vector predication (AMVP) mode. An MVP candidate list is determined based on the respective template matching costs. A bitstream of the video is generated based on the MVP candidate list.

In some embodiments, respective template matching costs of a plurality of motion vector prediction (MVP) candidates of a target video block of the video are determined. The plurality of MVP candidates are in an advanced motion vector predication (AMVP) mode. An MVP candidate list is determined based on the respective template matching costs. A bitstream of the video is generated based on the MVP candidate list. The bitstream is stored in a non-transitory computer-readable recording medium.

According to embodiments of the present disclosure, it is proposed that the template matching cost-based MVP candidate list construction and sorting may be applied to AMVP mode. In this way, the coding effectiveness and coding efficiency may be improved.

It is to be understood that the above method 1700 and/or method 1800 may be used in combination or separately. Any suitable combination of these methods may be applied. Scope of the present disclosure is not limited in this regard.

Implementations of the present disclosure can be described in view of the following clauses, the features of which can be combined in any reasonable manner.

Clause 1. A method for video processing, comprising: determining, during a conversion between a target video block of a video and a bitstream of the video, a set of motion vector prediction (MVP) candidates of the target video block based on decoded information of the target video block; sorting the set of MVP candidates based on respective template matching costs of the set of MVP candidates; and performing the conversion based on the sorting.

Clause 2. The method of clause 1, wherein the decoded information comprises at least one of: a block dimension of the target video block, a coding tool of the target video block, or a number of available MVP candidates in a group of MVP candidates of the target video block before being reordered.

Clause 3. The method of clause 2, wherein the coding tool of the target video block comprises at least one of: a combination of intra and inter predication (CIIP) coding tool, or a merge mode with motion vector difference (MMVD) coding tool.

Clause 4. The method of any of clauses 1-3, wherein determining the set of MVP candidates comprises: in accordance with a determination that a first MVP candidate belongs to a first candidate category, adding the first MVP candidate into the set of MVP candidates.

Clause 5. The method of clause 4, wherein the first candidate category comprises one of: a non-adjacent MVP candidate category, or a history-based motion vector predictor (HMVP) candidate category.

Clause 6. The method of any of clauses 1-3, wherein determining the set of MVP candidates comprises: in accordance with a determination that a group of MVP candidates belong to a first group type, adding the group of MVP candidates into the set of MVP candidates.

Clause 7. The method of any of clauses 1-6, wherein the set of MVP candidates comprises a joint group of MVP candidates containing MVP candidates of at least one candidate category.

Clause 8. The method of any of clauses 1-7, wherein determining the set of MVP candidates comprises: in accordance with a determination that the coding tool of the target video block comprises a first coding tool, determining a joint group of non-adjacent MVP candidate, non-adjacent temporal motion vector prediction (TMVP) candidate, and history-based motion vector predictor (HMVP) candidate as the set of MVP candidates.

Clause 9. The method of clause 8, wherein the first coding tool comprises at least one of: a regular merge mode coding tool, a combination of intra and inter predication (CIIP) merge mode coding tool, a merge mode with motion vector difference (MMVD) coding tool, a geometric partitioning mode (GPM) coding tool, a triangle partition mode (TPM) coding tool, or a subblock merge mode coding tool.

Clause 10. The method of any of clauses 1-9, wherein determining the set of MVP candidates comprises: in accordance with a determination that the coding tool of the target video block comprises a second coding tool, determining a joint group of adjacent MVP candidate, non-adjacent temporal motion vector prediction (TMVP) candidate, non-adjacent MVP candidate and history-based motion vector predictor (HMVP) candidate as the set of MVP candidates.

Clause 11. The method of clause 10, wherein the second coding tool comprises a template matching merge mode coding tool.

Clause 12. The method of any of clauses 1-11, wherein the set of MVP candidates comprise a joint group containing a partial of available MVP candidates of at least one candidate category.

Clause 13. The method of any of clauses 1-12, wherein determining the set of MVP candidates comprises: in accordance with a determination that the coding tool of the target video block comprises a third coding tool, determining a joint group of all or a partial of candidates of at least one candidate category as the set of MVP candidates.

Clause 14. The method of clause 13, wherein the third coding tool comprises at least one of: a regular merge mode coding tool, a combination of intra and inter predication (CIIP) merge mode coding tool, a merge mode with motion vector difference (MMVD) coding tool, a template matching (TM) coding tool, a geometric partitioning mode (GPM) coding tool, a triangle partition mode (TPM) coding tool, a subblock merge mode coding tool, a regular merge mode coding tool, an affine advanced motion vector predication (AMVP) coding tool.

Clause 15. The method of clause 13 or clause 14, wherein the at least one candidate category comprises at least one of the following: an adjacent neighboring MVP category, an adjacent neighboring MVP at a predefined location, a temporal motion vector prediction (TMVP) MVP category, a history-based motion vector predictor (HMVP) MVP category, a non-adjacent MVP category, a constructed MVP category, a pairwise MVP category, an inherited affine MV candidate category, a constructed affine MV candidate category, or a subblock-based temporal motion vector prediction (SbTMVP) candidate category.

Clause 16. The method of any of clauses 1-15, wherein sorting the set of MVP candidates based on the respective template matching costs comprises: sorting the set of MVP candidates in an ascending order based on the respective template matching costs.

Clause 17. The method of any of clauses 1-16, wherein the method is applied in constructing a block vector list of intra block copy (IBC) coded blocks or affine coded blocks.

Clause 18. A method for video processing, comprising: determining, during a conversion between a target video block of a video and a bitstream of the video, respective template matching costs of a plurality of motion vector prediction (MVP) candidates of the target video block, the plurality of MVP candidates being in an advanced motion vector predication (AMVP) mode; determining an MVP candidate list based on the respective template matching costs; and performing the conversion based on the MVP candidate list.

Clause 19. The method of clause 18, wherein the plurality of MVP candidates comprises at least one of the following: a non-adjacent MVP candidate, a history-based MVP (HMVP) candidate, or a history-based motion vector predictor (HMVP) candidate.

Clause 20. The method of clause 18 or clause 19, wherein determining the MVP candidate list comprises: selecting a first number of MVP candidates from the plurality of MVP candidates as the MVP candidate list, the first number of MVP candidates being of a second number of candidate categories.

Clause 21. The method of clause 20, wherein the candidate categories comprise at least one of: an adjacent MVP category, a non-adjacent MVP category, a non-adjacent temporal motion vector prediction (TMVP) MVP category, or a history-based motion vector predictor (HMVP) MVP category.

Clause 22. The method of clause 20 or clause 21, wherein the first number is less than, equal to or greater than the second number.

Clause 23. The method of any of clauses 20-22, wherein selecting the first number of MVP candidates comprises: selecting one MVP candidate from MVP candidates of a first candidate category.

Clause 24. The method of any of clauses 20-23, wherein no MVP candidate of a second candidate category is selected.

Clause 25. The method of any of clauses 20-24, wherein selecting the first number of MVP candidates comprises: selecting more than one MVP candidate of a third candidate category.

Clause 26. The method of any of clauses 20-25, wherein selecting the first number of MVP candidates comprises: selecting the first number of MVP candidates from adjacent MVPs, non-adjacent MVPs, non-adjacent temporal motion vector prediction (TMVP) MVPs, or history-based motion vector predictor (HMVP) MVPs.

Clause 27. The method of clause 26, wherein the first number comprises 4.

Clause 28. The method of any of clauses 20-26, wherein selecting the first number of MVP candidates as the MVP candidate list comprises: for a candidate category in the second number of candidate categories, sorting the MVP candidates of the candidate category based on respective template matching costs of the MVP candidates of the candidate category; and adding an MVP candidate with a minimum cost into the MVP candidate list.

Clause 29. The method of any of clauses 20-26, wherein selecting the first number of MVP candidates as the MVP candidate list comprises: sorting a group of adjacent MVP candidates in the plurality of MVP candidates based on respective template matching costs of the group of adjacent MVP candidates; adding an adjacent MVP candidate of the group of adjacent MVP candidates with a minimum cost into the MVP candidate list; sorting a joint group of non-adjacent MVP candidates, non-adjacent temporal motion vector prediction (TMVP) MVP candidates, and history-based motion vector predictor (HMVP) MVP candidates in the plurality of MVP candidates based on respective template matching costs of the joint group of MVP candidates; and adding a third number of MVP candidates in the joint group into the MVP candidate list based on an ascending order of the template matching costs.

Clause 30. The method of clause 29, wherein the third number comprises one of: 1 or 3.

Clause 31. The method of any of clauses 18-30, wherein the method is applied in constructing a block vector list of intra block copy (IBC) coded blocks or affine coded blocks.

Clause 32. The method of any of clauses 1-31, wherein the usage of the method is controlled with a coding level syntax.

Clause 33. The method of clause 32, wherein the coding level comprises at least one of: a prediction unit (PU) level, a coding unit (CU) level, a coding tree unit (CTU) level, a slice level, a picture level or a sequence level.

Clause 34. The method of any of clauses 1-33, wherein the conversion includes encoding the target video block into the bitstream.

Clause 35. The method of any of clauses 1-33, wherein the conversion includes decoding the target video block from the bitstream.

Clause 36. An apparatus for processing video data comprising a processor and a non-transitory memory with instructions thereon, wherein the instructions upon execution by the processor, cause the processor to perform a method in accordance with any of clauses 1-35.

Clause 37. A non-transitory computer-readable storage medium storing instructions that cause a processor to perform a method in accordance with any of clauses 1-35.

Clause 38. A non-transitory computer-readable recording medium storing a bitstream of a video which is generated by a method performed by a video processing apparatus, wherein the method comprises: determining, based on decoded information of a target video block of the video, a set of motion vector prediction (MVP) candidates of the target video block; sorting the set of MVP candidates based on respective template matching costs of the set of MVP candidates; and generating the bitstream based on the sorting.

Clause 39. A method for storing a bitstream of a video, comprising: determining, based on decoded information of a target video block of the video, a set of motion vector prediction (MVP) candidates of the target video block; sorting the set of MVP candidates based on respective template matching costs of the set of MVP candidates; generating the bitstream based on the sorting; and storing the bitstream in a non-transitory computer-readable recording medium.

Clause 40. A non-transitory computer-readable recording medium storing a bitstream of a video which is generated by a method performed by a video processing apparatus, wherein the method comprises: determining respective template matching costs of a plurality of motion vector prediction (MVP) candidates of a target video block of the video, the plurality of MVP candidates being in an advanced motion vector predication (AMVP) mode; determining an MVP candidate list based on the respective template matching costs; and generating the bitstream based on the MVP candidate list.

Clause 41. A method for storing a bitstream of a video, comprising: determining respective template matching costs of a plurality of motion vector prediction (MVP) candidates of a target video block of the video, the plurality of MVP candidates being in an advanced motion vector predication (AMVP) mode; determining an MVP candidate list based on the respective template matching costs; generating the bitstream based on the MVP candidate list; and storing the bitstream in a non-transitory computer-readable recording medium.

### Example Device

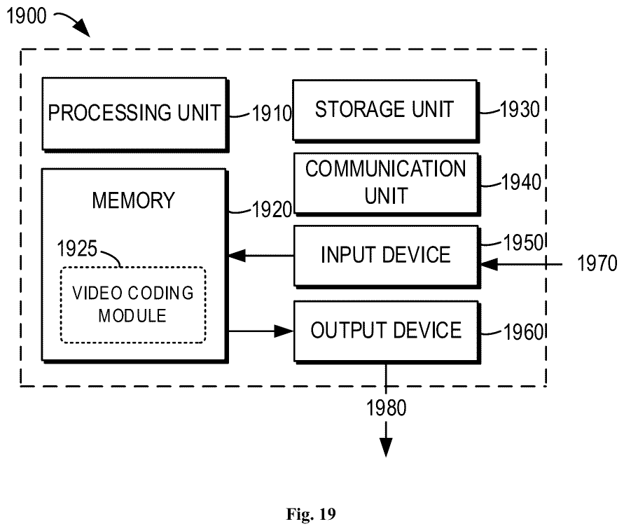

FIG. 19 illustrates a block diagram of a computing device 1900 in which various embodiments of the present disclosure can be implemented. The computing device 1900 may be implemented as or included in the source device 110 (or the video encoder 114 or 200) or the destination device 120 (or the video decoder 124 or 300).

It would be appreciated that the computing device 1900 shown in FIG. 19 is merely for purpose of illustration, without suggesting any limitation to the functions and scopes of the embodiments of the present disclosure in any manner.

As shown in FIG. 19, the computing device 1900 includes a general-purpose computing device 1900. The computing device 1900 may at least comprise one or more processors or processing units 1910, a memory 1920, a storage unit 1930, one or more communication units 1940, one or more input devices 1950, and one or more output devices 1960.

In some embodiments, the computing device 1900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1900 can support any type of interface to a user (such as “wearable” circuitry and the like).

The processing unit 1910 may be a physical or virtual processor and can implement various processes based on programs stored in the memory 1920. In a multi-processor system, multiple processing units execute computer executable instructions in parallel so as to improve the parallel processing capability of the computing device 1900. The processing unit 1910 may also be referred to as a central processing unit (CPU), a microprocessor, a controller or a microcontroller.

The computing device 1900 typically includes various computer storage medium. Such medium can be any medium accessible by the computing device 1900, including, but not limited to, volatile and non-volatile medium, or detachable and non-detachable medium. The memory 1920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1930 may be any detachable or non-detachable medium and may include a machine-readable medium such as a memory, flash memory drive, magnetic disk or another other media, which can be used for storing information and/or data and can be accessed in the computing device 1900.

The computing device 1900 may further include additional detachable/non-detachable, volatile/non-volatile memory medium. Although not shown in FIG. 19, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1940 communicates with a further computing device via the communication medium. In addition, the functions of the components in the computing device 1900 can be implemented by a single computing cluster or multiple computing machines that can communicate via communication connections. Therefore, the computing device 1900 can operate in a networked environment using a logical connection with one or more other servers, networked personal computers (PCs) or further general network nodes.

The input device 1950 may be one or more of a variety of input devices, such as a mouse, keyboard, tracking ball, voice-input device, and the like. The output device 1960 may be one or more of a variety of output devices, such as a display, loudspeaker, printer, and the like. By means of the communication unit 1940, the computing device 1900 can further communicate with one or more external devices (not shown) such as the storage devices and display device, with one or more devices enabling the user to interact with the computing device 1900, or any devices (such as a network card, a modem and the like) enabling the computing device 1900 to communicate with one or more other computing devices, if required. Such communication can be performed via input/output (I/O) interfaces (not shown).

In some embodiments, instead of being integrated in a single device, some or all components of the computing device 1900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1900 may be used to implement video encoding/decoding in embodiments of the present disclosure. The memory 1920 may include one or more video coding modules 1925 having one or more program instructions. These modules are accessible and executable by the processing unit 1910 to perform the functionalities of the various embodiments described herein.

In the example embodiments of performing video encoding, the input device 1950 may receive video data as an input 1970 to be encoded. The video data may be processed, for example, by the video coding module 1925, to generate an encoded bitstream. The encoded bitstream may be provided via the output device 1960 as an output 1980.

In the example embodiments of performing video decoding, the input device 1950 may receive an encoded bitstream as the input 1970. The encoded bitstream may be processed, for example, by the video coding module 1925, to generate decoded video data. The decoded video data may be provided via the output device 1960 as the output 1980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a target video block of a video and a bitstream of the video, a set of motion vector prediction (MVP) candidates of the target video block based on decoded information of the target video block;
sorting the set of MVP candidates based on respective template matching costs of the set of MVP candidates; and
performing the conversion based on the sorting.

2. The method of claim 1, wherein the decoded information comprises at least one of: a block dimension of the target video block, a coding tool of the target video block, or a number of available MVP candidates in a group of MVP candidates of the target video block before being reordered,
wherein the coding tool of the target video block comprises at least one of: a combination of intra and inter predication (CIIP) coding tool, or a merge mode with motion vector difference (MMVD) coding tool.

3. The method of claim 1, wherein determining the set of MVP candidates comprises:
in accordance with a determination that a first MVP candidate belongs to a first candidate category, adding the first MVP candidate into the set of MVP candidates,
wherein the first candidate category comprises one of: a non-adjacent MVP candidate category, or a history-based MVP (HMVP) candidate category.

4. The method of claim 1, wherein determining the set of MVP candidates comprises:
in accordance with a determination that a group of MVP candidates belong to a first group type, adding the group of MVP candidates into the set of MVP candidates.

5. The method of claim 1, wherein the set of MVP candidates comprises a joint group of MVP candidates containing MVP candidates of at least one candidate category.

6. The method of claim 1, wherein determining the set of MVP candidates comprises:
in accordance with a determination that a coding tool of the target video block comprises a first coding tool, determining a joint group of non-adjacent MVP candidate, non-adjacent temporal motion vector prediction (TMVP) candidate, and history-based MVP (HMVP) candidate as the set of MVP candidates,
wherein the first coding tool comprises at least one of:
a regular merge mode coding tool,
a combination of intra and inter predication (CIIP) merge mode coding tool,
a merge mode with motion vector difference (MMVD) coding tool,
a geometric partitioning mode (GPM) coding tool,
a triangle partition mode (TPM) coding tool, or
a subblock merge mode coding tool.

7. The method of claim 1, wherein determining the set of MVP candidates comprises:
in accordance with a determination that a coding tool of the target video block comprises a second coding tool, determining a joint group of adjacent MVP candidate, non-adjacent temporal motion vector prediction (TMVP) candidate, non-adjacent MVP candidate and history-based MVP (HMVP) candidate as the set of MVP candidates,
wherein the second coding tool comprises a template matching merge mode coding tool.

8. The method of claim 1, wherein the set of MVP candidates comprise a joint group containing a partial of available MVP candidates of at least one candidate category, or
wherein determining the set of MVP candidates comprises: in accordance with a determination that a coding tool of the target video block comprises a third coding tool, determining a joint group of all or a partial of candidates of at least one candidate category as the set of MVP candidates,
wherein the third coding tool comprises at least one of:
a regular merge mode coding tool,
a combination of intra and inter predication (CIIP) merge mode coding tool,
a merge mode with motion vector difference (MMVD) coding tool,
a template matching (TM) coding tool,
a geometric partitioning mode (GPM) coding tool,
a triangle partition mode (TPM) coding tool,
a subblock merge mode coding tool,
a regular merge mode coding tool, or
an affine advanced motion vector predication (AMVP) coding tool, or
wherein the at least one candidate category comprises at least one of:
an adjacent neighboring MVP category,
an adjacent neighboring MVP at a predefined location,
a temporal motion vector prediction (TMVP) MVP category,
a history-based MVP (HMVP) MVP category,
a non-adjacent MVP category,
a constructed MVP category,
a pairwise MVP category,
an inherited affine MV candidate category,
a constructed affine MV candidate category, or
a subblock-based temporal motion vector prediction (SbTMVP) candidate category.

9. The method of claim 1, wherein sorting the set of MVP candidates based on the respective template matching costs comprises:
sorting the set of MVP candidates in an ascending order based on the respective template matching costs.

10. The method of claim 1, further comprising:
determining respective template matching costs of a plurality of motion vector prediction (MVP) candidates of the target video block, the plurality of MVP candidates being in an advanced motion vector predication (AMVP) mode; and
determining an MVP candidate list based on the respective template matching costs, wherein the conversion is performed based on the MVP candidate list.

11. The method of claim 10, wherein the plurality of MVP candidates comprises at least one of:
a non-adjacent MVP candidate, or
a history-based MVP (HMVP) candidate.

12. The method of claim 10, wherein determining the MVP candidate list comprises:
selecting a first number of MVP candidates from the plurality of MVP candidates as the MVP candidate list, the first number of MVP candidates being of a second number of candidate categories, wherein the first number is less than, equal to or greater than the second number,
wherein the candidate categories comprise at least one of:
an adjacent MVP category,
a non-adjacent MVP category,
a non-adjacent temporal motion vector prediction (TMVP) MVP category, or
a history-based MVP (HMVP) MVP category.

13. The method of claim 12, wherein selecting the first number of MVP candidates comprises: selecting one MVP candidate from MVP candidates of a first candidate category, or
wherein no MVP candidate of a second candidate category is selected, or
wherein selecting the first number of MVP candidates comprises: selecting more than one MVP candidate of a third candidate category.

14. The method of claim 12, wherein selecting the first number of MVP candidates comprises:
selecting the first number of MVP candidates from adjacent MVPs, non-adjacent MVPs, non-adjacent temporal motion vector prediction (TMVP) MVPs, or history-based MVP (HMVP) MVPs,
wherein the first number comprises 4.

15. The method of claim 12, wherein selecting the first number of MVP candidates as the MVP candidate list comprises:
for a candidate category in the second number of candidate categories,
sorting the MVP candidates of the candidate category based on respective template matching costs of the MVP candidates of the candidate category; and
adding an MVP candidate with a minimum cost into the MVP candidate list.

16. The method of claim 12, wherein selecting the first number of MVP candidates as the MVP candidate list comprises:
sorting a group of adjacent MVP candidates in the plurality of MVP candidates based on respective template matching costs of the group of adjacent MVP candidates;
adding an adjacent MVP candidate of the group of adjacent MVP candidates with a minimum cost into the MVP candidate list;
sorting a joint group of non-adjacent MVP candidates, non-adjacent temporal motion vector prediction (TMVP) MVP candidates, and history-based MVP (HMVP) MVP candidates in the plurality of MVP candidates based on respective template matching costs of the joint group of MVP candidates; and
adding a third number of MVP candidates in the joint group into the MVP candidate list based on an ascending order of the template matching costs,
wherein the third number comprises one of: 1 or 3.

17. The method of claim 1, wherein the conversion includes encoding the target video block into the bitstream, or
wherein the conversion includes decoding the target video block from the bitstream.

18. An apparatus for processing video data comprising a processor and a non-transitory memory with instructions thereon, wherein the instructions upon execution by the processor, cause the processor to:
determine, during a conversion between a target video block of a video and a bitstream of the video, a set of motion vector prediction (MVP) candidates of the target video block based on decoded information of the target video block;
sort the set of MVP candidates based on respective template matching costs of the set of MVP candidates; and
perform the conversion based on the sorting.

19. A non-transitory computer-readable storage medium storing instructions that cause a processor to perform a method performed by a video processing apparatus, wherein the method comprises:
determining, during a conversion between a target video block of a video and a bitstream of the video, a set of motion vector prediction (MVP) candidates of the target video block based on decoded information of the target video block;
sorting the set of MVP candidates based on respective template matching costs of the set of MVP candidates; and
performing the conversion based on the sorting.

20. A non-transitory computer-readable recording medium storing a bitstream of a video which is generated by a method performed by a video processing apparatus, wherein the method comprises:
determining, based on decoded information of a target video block of the video, a set of motion vector prediction (MVP) candidates of the target video block;
sorting the set of MVP candidates based on respective template matching costs of the set of MVP candidates; and
generating the bitstream based on the sorting.
